(19) United States
(12) Patent Application Publication
(10) Pub. No.: US 2015/0103565 A1
(43) Pub. Date: Apr. 16, 2015

(54) DC-TO-DC CONVERTER

(71) Applicant: FUJITSU LIMITED, Kawasaki-shi (JP)

(72) Inventors: HIROSHI SHIMAMORI, Yokosuka (JP); Yukio Yoshino, Tokorozawa (JP)

(21) Appl. No.: 14/510,524

(22) Filed: Oct. 9, 2014

(30) Foreign Application Priority Data
Oct. 15, 2013 (JP) 2013-214968

(51) Int. Cl. H02M 3/335

(52) U.S. Cl. CPC H02M 3/33538
USPC 363/21.09

(57) ABSTRACT

A direct current to direct current converter includes: a transformer configured to vary a direct-current voltage applied to a first side and output the varied direct-current voltage to a second side; a switch configured to periodically switch the voltage applied to the first side of the transformer; a load-current detecting circuit configured to detect load current flowing in the second side of the transformer; and a switching-frequency switching circuit configured to switch, when a magnitude of the load current detected by the load-current detecting circuit is smaller than a predetermined threshold, a frequency for switching the switch from a first frequency to a second frequency lower than the first frequency, and to switch, when the magnitude of the load current detected by the load-current detecting circuit is larger than the predetermined threshold, the frequency for switching the switch from the second frequency to the first frequency.

### CROSS-REFERENCE TO RELATED APPLICATION

This application is based upon and claims the benefit of priority of the prior Japanese Patent Application No. 2013-214968, filed on Oct. 15, 2013, the entire contents of which are incorporated herein by reference.

### FIELD

The embodiments discussed herein are related to a direct current to direct current (DC-to-DC) converter.

### BACKGROUND

In DC-to-DC converters used for power-supply devices and so on, a variety of technologies for improving the power conversion efficiencies have been disclosed in order to deal with energy saving regulations in recent years.

For example, there has been a known switching power-supply device including a rectifier circuit, a switching element, a power converter, a detector, and a control circuit. The rectifier circuit converts power from an alternating-current power supply into direct-current power, and the switching element intermittently switches on the direct-current power, obtained from the rectifier circuit, via a primary winding of a transformer. The power converter has a secondary winding and a tertiary winding that induce power corresponding to the power supplied to the primary winding of the transformer via the intermittent switching of the switching element. The power converter rectifies and smooths the power output from the secondary winding and supplies the resulting power to a load circuit at the secondary side. The detector is driven by power obtained by rectifying and smoothing the power obtained from the tertiary winding, to detect the power supplied from the secondary winding to the load circuit, in order to control the power so as to obtain a predetermined voltage and a predetermined current. The control circuit controls the on period of the switching element so that the power supplied to the secondary side reaches a predetermined value, based on a signal detected by the detector. In the above-described switching power-supply device, in a mode in which equipment serving as the load circuit coupled to an output of the secondary side operates, the switching element is subjected to pulse width modulation (PWM) control with a certain fundamental frequency, and in a mode in which the operation of the equipment stops, the fundamental frequency is controlled so as to shift to a lower frequency. The control circuit performs control so that, during the PWM control with the fundamental frequency in the equipment operation mode, the on time of the switching element reaches a minimum pulse duration when the output power decreases. Also, when the fundamental frequency shifts to the lower frequency in the equipment stop mode and the frequency decreases, the control circuit performs control so that the minimum on-pulse duration increases gradually in conjunction with the reduction in the frequency. The minimum on-pulse duration of the switching element is controlled so as to increase when a voltage of the alternating-current power is low, and the on-pulse duration of the switching element is controlled so as to decrease when the voltage of the alternating-current power is high.

There is also a known switching power supply that includes a transformer, a secondary direct-current power supply, a constant-voltage control circuit, a switching-power-supply-control integrated circuit, startup resistors, a feedback direct-current power supply, a switching element, and a switching-frequency switching circuit. The transformer has a primary winding, a secondary winding, and a feedback winding. The secondary direct-current power supply rectifies and smooths an output of the secondary winding, the constant-voltage control circuit is coupled to the secondary direct-current power supply, and a feedback control circuit maintains an output voltage. The feedback direct-current power supply rectifies and smooths the output of the feedback winding. The switching-power-supply-control integrated circuit has at least a power-supply voltage terminal, a ground terminal, an oscillation control terminal, a current limit terminal, a feedback terminal, and an oscillation-constant terminal. The startup resistors are coupled between a power-supply voltage terminal of the switching-power-supply-control integrated circuit and an input voltage terminal, and the feedback direct-current power supply is coupled to the power-supply voltage terminal of the switching-power-supply-control integrated circuit. The switching element is coupled to the input voltage terminal via the primary winding and has an oscillation frequency controlled in accordance with an oscillation-control terminal voltage of the integrated circuit. The switching-frequency switching circuit is coupled to the oscillation-constant terminal to reduce the oscillation frequency of the switching element when the load power is reduced or when there is no load.

The followings are reference documents:

[Document 1] Japanese Laid-open Patent Publication No. 2004-304885 and

[Document 2] Japanese Laid-open Patent Publication No. 9-117134.

### SUMMARY

According to an aspect of the invention, a direct current to direct current converter includes: a transformer configured to vary a direct-current voltage applied to a first side and output the varied direct-current voltage to a second side; a switch configured to periodically switch the voltage applied to the first side of the transformer; a load-current detecting circuit configured to detect load current flowing in the second side of the transformer; and a switching-frequency switching circuit configured to switch, when a magnitude of the load current detected by the load-current detecting circuit is smaller than a predetermined threshold, a frequency for switching the switch from a first frequency to a second frequency lower than the first frequency, and to switch, when the magnitude of the load current detected by the load-current detecting circuit is larger than the predetermined threshold, the frequency for switching the switch from the second frequency to the first frequency.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit block diagram of a DC-to-DC converter in related art;

FIG. 2A is an internal-circuit block diagram of a PWM-control drive circuit;

FIG. 2B is a timing chart of the PWM-control drive circuit;

FIG. 3 is a circuit block diagram of a DC-to-DC converter according to a first embodiment;

FIG. 4A is an internal-circuit block diagram of a PWM-control drive circuit;

FIG. 4B is a circuit block diagram depicting a coupling relationship between the PWM-control drive circuit and a switching-frequency switching circuit;

FIG. 5 is a timing chart of the DC-to-DC converter illustrated in FIG. 3;

FIG. 6A is a timing chart illustrating switching of the oscillation frequency of an oscillator;

FIG. 6B illustrates a B-H curve of a transformer which corresponds to FIG. 6A;

FIG. 7 is a circuit block diagram illustrating a coupling relationship between a PWM-control drive circuit and a switching-frequency switching circuit in a DC-to-DC converter according to a second embodiment;

FIG. 8A is a timing chart of the DC-to-DC converter illustrated in FIG. 7;

FIG. 8B is a partially enlarged chart of a portion denoted by a dashed-line ellipse A in FIG. 8A;

FIG. 8C is a partially enlarged chart of a portion denoted by a dashed-line ellipse B in FIG. 8A;

FIG. 9A is a timing chart illustrating switching of the oscillation frequency of an oscillator in the DC-to-DC converter illustrated in FIG. 7;

FIG. 9B illustrates a B-H curve of the transformer which corresponds to FIG. 9A;

FIG. 10 is a circuit block diagram illustrating a coupling relationship between a PWM-control drive circuit and a switching-frequency switching circuit in a DC-to-DC converter according to a third embodiment;

FIG. 11A is a timing chart of the DC-to-DC converter illustrated in FIG. 10;

FIG. 11B is a partially enlarged chart of a portion indicated by a dashed-line ellipse A in FIG. 11A;

FIG. 11C is a partially enlarged chart of a portion indicated by a dashed-line ellipse B in FIG. 11A;

FIG. 12A is a circuit block diagram illustrating a coupling relationship between a PWM-control drive circuit and a switching-frequency switching circuit in a DC-to-DC converter according to a fourth embodiment;

FIG. 12B is an internal circuit block diagram of a variable resistor in FIG. 12A;

FIG. 13 is a flowchart illustrating an example of processing executed by the variable resistor driver in the DC-to-DC converter;

FIG. 14 is a flowchart illustrating another example of processing executed by the variable resistor driver in the DC-to-DC converter; and

FIG. 15 is a flowchart illustrating yet another example of the processing executed by the variable resistor driver in the DC-to-DC converter.

### DESCRIPTION OF EMBODIMENTS

A DC-to-DC converter according to the present disclosure will be described below with reference to the accompanying drawings. However, the technical scope of the present disclosure is not limited to embodiments thereof.

Before a description is given of the DC-to-DC converter according to the embodiments, the DC-to-DC converter in related art will be described in more detail.

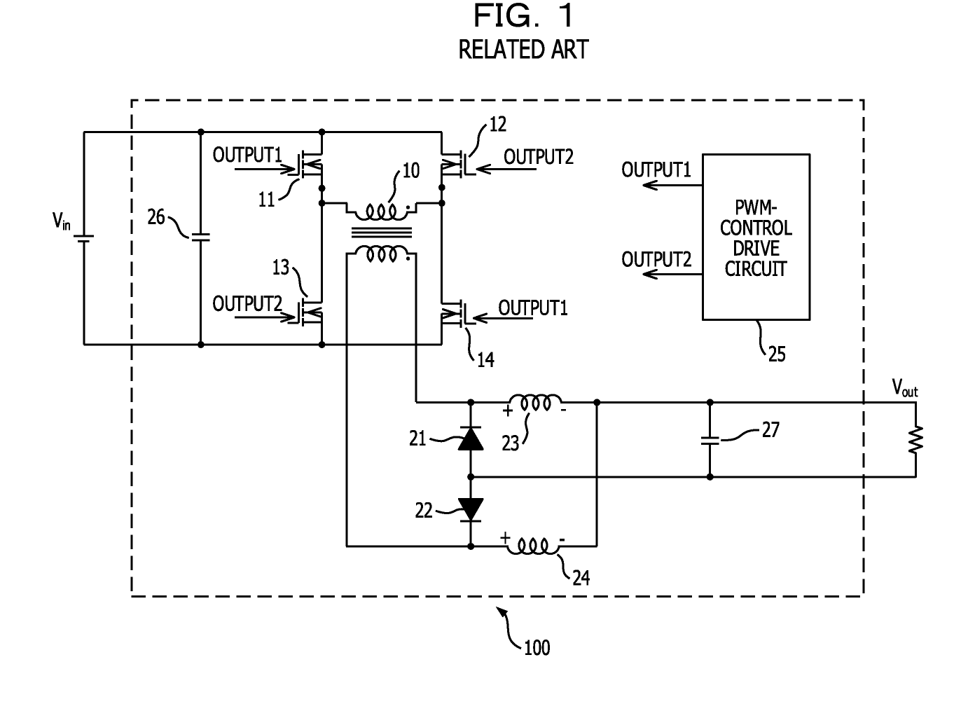

FIG. 1 is a circuit block diagram of the DC-to-DC converter in the related art.

A DC-to-DC converter 100 includes a transformer 10, a first switch 11, a second switch 12, a third switch 13, a fourth switch 14, a first diode 21, a second diode 22, a first reactance element 23, and a second reactance element 24. The DC-to-DC converter 100 further includes a PWM-control drive circuit 25, a first capacitor 26, and a second capacitor 27.

The transformer 10 has a primary winding to which a rectangular wave is applied and a secondary winding that outputs a voltage resulting from reduction of a voltage applied to the primary winding. The first switch 11, the second switch 12, the third switch 13, and the fourth switch 14 are n-type metal oxide semiconductor (nMOS) transistors and switch the voltage applied to the primary winding of the transformer 10.

A first output terminal OUTPUT1 of the PWM-control drive circuit 25 is coupled to gates of the first switch 11 and the fourth switch 14, and a second output terminal OUTPUT2 of the PWM-control drive circuit 25 is coupled to gates of the second switch 12 and the third switch 13. Drains of the first switch 11 and the second switch 12 are coupled to a positive terminal of a direct-current power supply, and sources of the third switch 13 and the fourth switch 14 are coupled to a negative terminal of the direct-current power supply. A source of the first switch 11 and a drain of the third switch 13 are coupled to one terminal of the primary winding of the transformer 10, and a source of the second switch 12 and a drain of the fourth switch 14 are coupled to another terminal of the primary winding of the transformer 10.

The first switch 11, the second switch 12, the third switch 13, and the fourth switch 14 are put into three switching states, namely, first to third switching states, based on signals output from the first output terminal OUTPUT1 and the second output terminal OUTPUT2 of the PWM-control drive circuit 25. The first switch state is a state in which the first switch 11 and the fourth switch 14 are turned on, the second switch 12 and the third switch 13 are turned off, and a positive voltage is applied to the primary winding of the transformer 10. The second switch state is a state in which the first switch 11 and the fourth switch 14 are turned off, the second switch 12 and the third switch 13 are turned on, and a negative voltage is applied to the primary winding of the transformer 10. The third switch state is a state in which the first switch 11, the second switch 12, the third switch 13, and the fourth switch 14 are all turned off. In the third switch state, current flows via the first diode 21 or the second diode 22, and voltages in the primary winding and the secondary winding of the transformer 10 become zero, so that a magnetic flux density in the transformer 10 is maintained. For example, when the first switch 11, the second switch 12, the third switch 13, and the fourth switch 14 change from the first switch state to the third switch state, the magnetic flux density in the transformer 10 is maintained at the last magnetic flux density in the first switch state. When the first switch 11, the second switch 12, the third switch 13, and the fourth switch 14 change from the second switch state to the third switch state, the magnetic flux density in the transformer 10 is maintained at the last magnetic flux density in the second switch state.

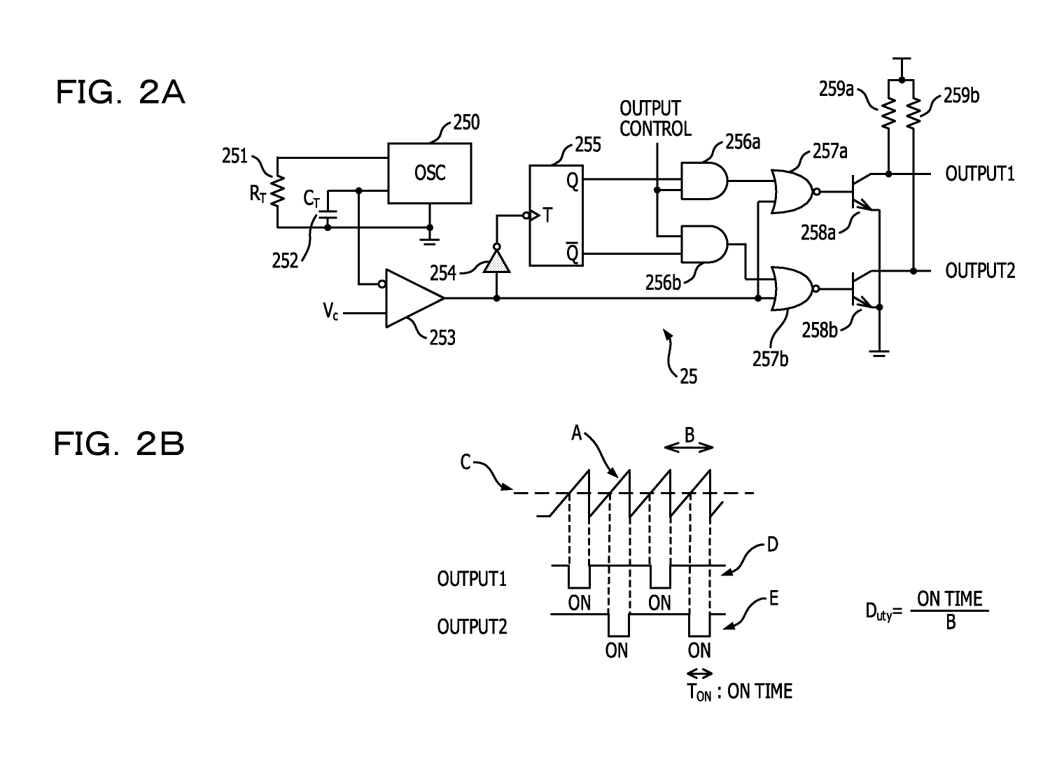

FIG. 2A is an internal-circuit block diagram of the PWM-control drive circuit 25, and FIG. 2B is a timing chart of the PWM-control drive circuit 25.

The PWM-control drive circuit 25 includes an oscillator 250, an oscillation resistor 251, an oscillation capacitor 252, a comparator 253, an inversion element 254, and a T flip-flop 255. The PWM-control drive circuit 25 further includes a first AND element 256a, a second AND element 256b, a first NOR element 257a, and a second NOR element 257b. The PWM-control drive circuit 25 further includes a first transistor 258a, a second transistor 258b, a first output resistor 259a, and a second output resistor 259b.

The oscillator 250 outputs an oscillation signal having a frequency corresponding to the resistance value of the oscillation resistor 251 and the capacitance value of the oscillation capacitor 252. When the resistance value of the oscillation resistor 251 is indicated by R_{T} [kΩ] and the capacitance value of the oscillation capacitor 252 is indicated by C_{T} [μF], the oscillation frequency f_{OSC} [kHz] of the oscillator 250 is given by:

$${f}_{OSC} \approx \frac{1.2`}{{R}_{T} \times {C}_{T}} \qquad ( 1 )$$

In FIG. 2B, the oscillation signal of the oscillator 250 is denoted by an arrow A, and the oscillation period of the oscillation signal of the oscillator 250 is denoted by a bi-directional arrow B.

The comparator 253 compares an inverted voltage of the oscillation signal of the oscillator 250 with a reference voltage V_{c} denoted by an arrow C in FIG. 2B. The T flip-flop 255 outputs a toggle signal in accordance with a signal output from the comparator 253. The first transistor 258a and the second transistor 258b output signals via the first output terminal OUTPUT1 and the second output terminal OUTPUT2, respectively, in accordance with signals output from the comparator 253 and the T flip-flop 255 and an output control signal. In FIG. 2B, an arrow D and an arrow E denote the signals output via the first output terminal OUTPUT1 and the second output terminal OUTPUT2, respectively. In the PWM-control drive circuit 25, the periods in which the first switch 11, the second switch 12, the third switch 13, and the fourth switch 14 are turned on are set equal to each other.

The ratio of the magnitude of a voltage Vᵢₙ input to the DC-to-DC converter 100 versus the magnitude of a voltage Vₒᵤₜ output therefrom is determined by the turns ratio of the transformer 10 and the duty ratio of the signals output from the first output terminal OUTPUT1 and the second output terminal OUTPUT2. The larger the turns ratio of the primary winding versus the secondary winding of the transformer 10 becomes, and the lower the voltage output from the transformer 10 becomes compared with the voltage input thereto, the lower the output voltage Vₒᵤₜ becomes. Also, the smaller the duty ratio of the signal output from the first output terminal OUTPUT1 versus the signal output from the second output terminal OUTPUT2 becomes, and the smaller the periods in which the first switch 11, the second switch 12, the third switch 13, and the fourth switch 14 are turned on become, the lower the output voltage Vₒᵤₜ becomes.

In the DC-to-DC converter 100, since the primary winding and the secondary winding of the transformer 10 are isolated from each other, it is possible to isolate the input side and the output side. Also, in the DC-to-DC converter 100, by changing the duty ratio of the signal output from the first output terminal OUTPUT1 and the signal output from the second output terminal OUTPUT2, it is possible to easily change the magnitude of the output voltage Vₒᵤₜ.

The DC-to-DC converter 100, however, suffers from a problem in that it is not easy to reduce the power consumption at light load, since the oscillation frequency of the oscillator 250 does not vary regardless of the magnitude of current flowing in a load coupled to an output end. Power semiconductor devices, such as the first switch 11, the second switch 12, the third switch 13, the fourth switch 14, the first diode 21, and the second diode 22, in the DC-to-DC converter 100 are designed so as to suppress the power consumption at heavy load. That is, those power semiconductor devices are configured with large-size transistors so that the resistance loss, commonly represented by I²R, decreases. However, when the power semiconductor devices are configured with large-size transistors, the parasitic capacitances of the transistors increase and the capacitance loss, commonly represented by CV²f, increases.

In the DC-to-DC converter 100, when the load current is relatively large, for example, larger than or equal to 50% of a rated load current, and resistance loss among multiple types of loss in the power semiconductor devices is dominant, it is possible to reduce the power consumption. The DC-to-DC converter 100, however, has a problem in that it is not easy to reduce the power consumption when the load current is relatively small, for example, smaller than 50% of the rated load current, and the capacitance loss among losses of the power semiconductor devices is dominant.

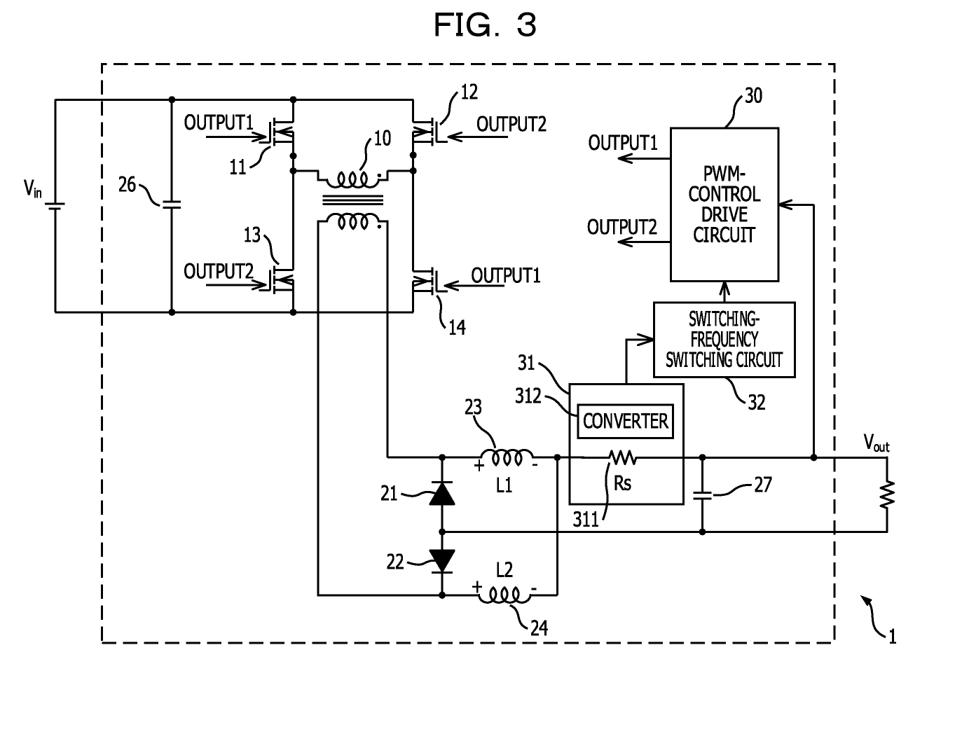

FIG. 3 is a circuit block diagram of a DC-to-DC converter according to a first embodiment.

A DC-to-DC converter 1 according to the first embodiment is different from the above-described DC-to-DC converter 100 in that the DC-to-DC converter 1 includes a PWM-control drive circuit 30 instead of the PWM-control drive circuit 25. The DC-to-DC converter 1 is also different from the DC-to-DC converter 100 in that the DC-to-DC converter 1 includes a load-current detecting circuit 31 and a switching-frequency switching circuit 32.

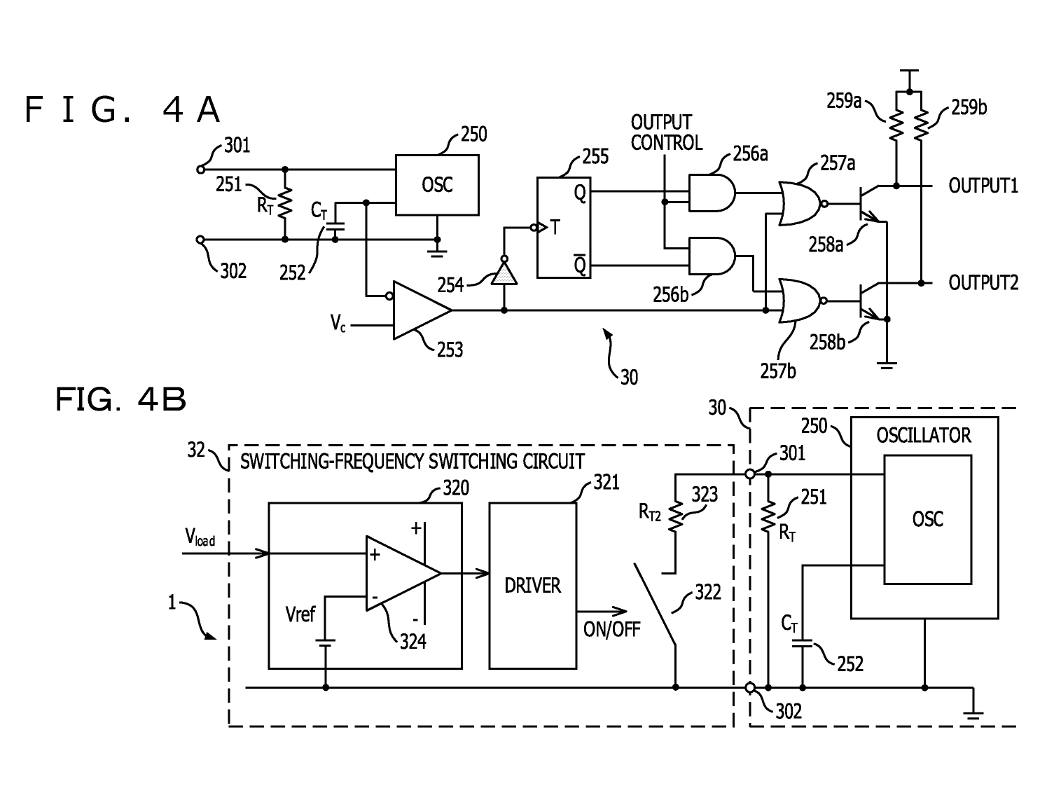

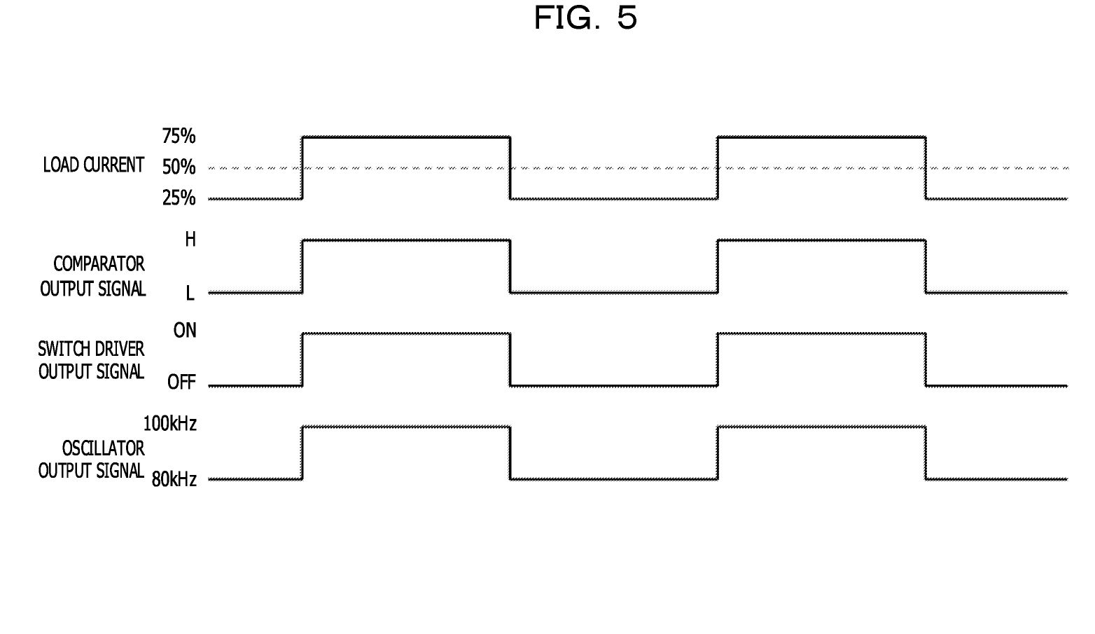

FIG. 4A is an internal-circuit block diagram of the PWM-control drive circuit 30, and FIG. 4B is a circuit block diagram depicting a coupling relationship between the PWM-control drive circuit 30 and the switching-frequency switching circuit 32. FIG. 5 is a timing chart of the DC-to-DC converter 1.

The PWM-control drive circuit 30 is different from the PWM-control drive circuit 25 in that connection terminals 301 and 302 that may be coupled to connection terminals of the switching-frequency switching circuit 32 are arranged between terminals of the oscillation resistor 251.

The load-current detecting circuit 31 has a load-current detecting resistor 311 and a load-current converter 312. One end of the load-current detecting resistor 311 is coupled to inductors 23 and 24, and another end of the load-current detecting resistor 311 is coupled to an output terminal. The load-current converter 312 detects the magnitude of a voltage drop V_{load} due to load current flowing in the load-current detecting resistor 311, and outputs a load-current signal corresponding to the voltage drop V_{load} due to the load current.

The switching-frequency switching circuit 32 has a load-current detector 320, a switch driver 321, a switch 322, and a second oscillation resistor 323. The load-current detector 320 includes a comparator 324 that compares the magnitude of the voltage drop V_{load} due to the load current with a reference voltage V_{ref}. When the voltage drop V_{load} due to the load current is larger than the reference voltage V_{ref}, the comparator 324 outputs “1”. Also, when the magnitude of the voltage drop V_{load} due to the load current is smaller than the reference voltage V_{ref}, the comparator 324 outputs “0”. In one example, the reference voltage V_{ref} may be set to have a magnitude corresponding to the voltage drop V_{load} when 50% of a rated current flows in the load-current detecting resistor 311. The switch driver 321 turns on or off the switch 322 in accordance with the signal output from the comparator 324. The switch driver 321 turns on the switch 322 when “1” is output from the comparator 324, and turns off the switch 322 when “0” is output from the comparator 324. The second oscillation resistor 323, together with the switch 322 coupled in series therewith, is coupled in parallel with the oscillation resistor 251 in the PWM-control drive circuit 25 via the connection terminals 301 and 302. The resistance value of the second oscillation resistor 323 is indicated by R_{T2}.

When the magnitude of the voltage drop V_{load} due to the load current is smaller than the reference voltage V_{ref}, the switch 322 is turned off, and thus the second oscillation resistor 323 is not coupled to the oscillator 250. In this case, the oscillation frequency f_{OSC} [kHz] of the oscillator 250 is given by:

$${f}_{OSC} \approx \frac{1.2`}{{R}_{T} \times {C}_{T}} \qquad ( 2 )$$

On the other hand, when the magnitude of the voltage drop V_{load} due to the load current is larger than the reference voltage V_{ref}, the switch 322 is turned on. When the switch 322 is turned on, the second oscillation resistor 323, together with the oscillation resistor 251, is coupled to the oscillator 250. In this case, the oscillation frequency f_{OSC} [kHz] of the oscillator 250 is given by:

$${f}_{OSC} \approx \frac{1.2`}{{R}_{T}^{′} \times {C}_{T}} \qquad ( 3 )$$

where R_{T}′ indicates a resistance value given by:

$${R}_{T}^{′} = \frac{{R}_{T} \times {R}_{T 2}}{( {R}_{T} + {R}_{T 2} )} \qquad ( 4 )$$

In the DC-to-DC converter 1, the resistance value R_{T} of the oscillation resistor 251 and the resistance value R_{T2} of the second oscillation resistor 323 are defined to thereby define the ratio of the oscillation frequency f_{OSC} of the oscillator 250 when the load current is small versus the oscillation frequency f_{OSC} when the load current is large. For example, if the oscillation frequency f_{OSC} given by equation (3) is 100 [kHz], and the resistance value R_{T2} of the second oscillation resistor 323 is 4R_{T}, that is, four times the resistance value R_{T} of the oscillation resistor 251, then the oscillation frequency f_{OSC} given by equation (2) is 80 [kHz].

In the DC-to-DC converter 1, when the load current is small, the oscillation frequency f_{OSC} of the oscillator 250 is made to be smaller than that when the load current is large, to reduce the capacitance loss at low load. This makes it possible to reduce the power consumption. In the DC-to-DC converter 1, however, in order to cause the oscillator 250 to operate at two oscillation frequencies f_{OSC}, a relatively large transformer is used as the transformer 10.

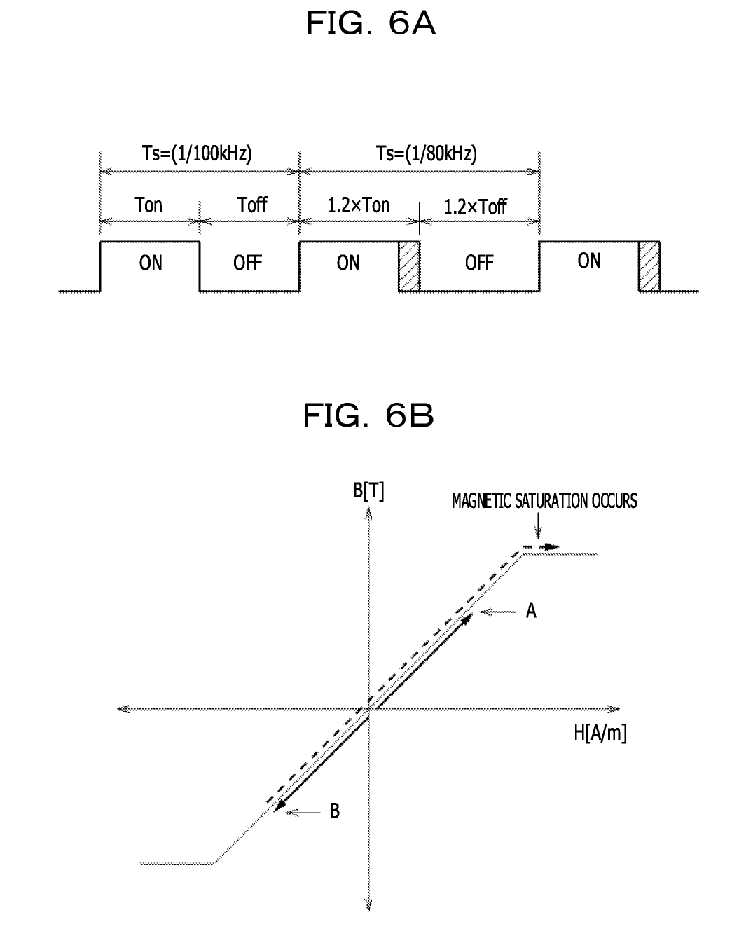

FIG. 6A is a timing chart illustrating switching of the oscillation frequency f_{OSC} of the oscillator 250, and FIG. 6B illustrates a B-H curve of the transformer 10 which corresponds to FIG. 6A. In FIG. 6A, the oscillation frequency f_{OSC} of the oscillator 250, which has been 100 [kHz], is switched to 80 [kHz], upon a decrease in the magnitude of the load current.

When the oscillation frequency f_{OSC} of the oscillator 250 is 100 [kHz], the transformer 10 transitions within a region denoted by arrows A and B in FIG. 6B, and thus there is no possibility of magnetic saturation. However, when the load current decreases, and the oscillation frequency f_{OSC} of the oscillator 250 is switched from 100 [kHz] to 80 [kHz], the wavelength increases as the frequency decreases. The length of an on period Tₒₙ in which the first switch 11 and the fourth switch 14 are turned on and the length of an on period Tₒₙ in which the second switch 12 and the third switch 13 are turned on increase in proportion to an increase in the wavelength. For example, when the oscillation frequency f_{OSC} of the oscillator 250 is switched from 100 [kHz] to 80 [kHz], and a wavelength T_{S} becomes 1.2 times longer, the on period Tₒₙ also becomes 1.2 times longer.

In the DC-to-DC converter 1, when the oscillation frequency f_{OSC} of the oscillator 250 is switched so as to decrease, and the on period Tₒₙ increases, the magnetic flux becomes unbalanced. Consequently, there is a possibility that magnetic saturation occurs in the first quadrant, as illustrated in FIG. 6B. When magnetic saturation occurs, excessive current flows to the first to fourth switches 11 to 14, causing a deterioration of the performance of the first to fourth switches 11 to 14, which may result in breakage of the first to fourth switches 11 to 14. A large-size transformer is used as the transformer 10 in the DC-to-DC converter 1 so as to ensure that the transformer 10 is not magnetically saturated even when the oscillation frequency f_{OSC} of the oscillator 250 is switched to reduce the period in which the first to fourth switches 11 to 14 are switched.

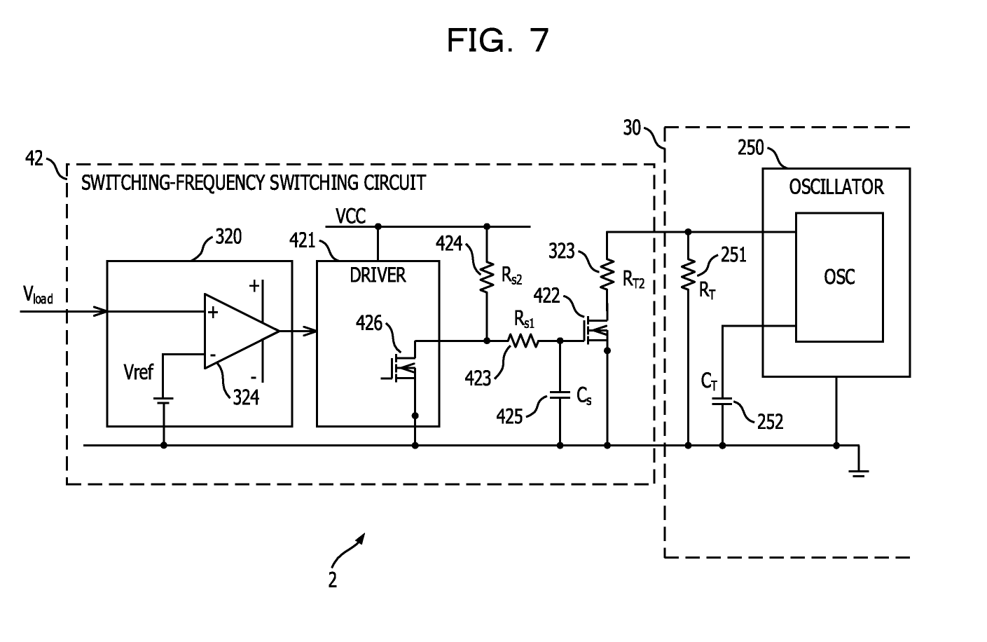

FIG. 7 is a circuit block diagram illustrating a coupling relationship between a PWM-control drive circuit and a switching-frequency switching circuit in a DC-to-DC converter according to a second embodiment.

A DC-to-DC converter 2 is different from the DC-to-DC converter 1 in that a switching-frequency switching circuit 42 is provided instead of the switching-frequency switching circuit 32.

The switching-frequency switching circuit 42 is different from the switching-frequency switching circuit 32 in that a switch driver 421 is provided instead of the switch driver 321. The switching-frequency switching circuit 42 is also different from the switching-frequency switching circuit 32 in that a switch 422 is provided instead of the switch 322. The switching-frequency switching circuit 42 is also different from the switching-frequency switching circuit 32 in that the switching-frequency switching circuit 42 has a first switch resistor 423, a second switch resistor 424, and a switch capacitor 425.

The switch driver 421 has a drive switch 426. The drive switch 426 is an nMOS transistor and is turned on or off in accordance with a signal output from the load-current detector 320. A gate of the drive switch 426 is coupled to an output terminal of the load-current detector 320, a source of the drive switch 426 is coupled to ground, and a drain of the drive switch 426 is coupled to one end of the first switch resistor 423 and the second switch resistor 424.

The switch 422 is an nMOS transistor and is turned on or off in accordance with the on or off state of the drive switch 426. A gate of the switch 422 is coupled to a power-supply voltage VCC via the first switch resistor 423 and the second switch resistor 424 and is coupled to ground via the switch capacitor 425. When the drive switch 426 is turned on, a voltage at the gate of the switch 422 falls from the power-supply voltage VCC to a ground level in a fall time T_{f} corresponding to a time constant τ_{f} determined by the magnitude of a resistance value Rₛ₁ of the first switch resistor 423 and the magnitude of a capacitance value Cₛ₁ of the switch capacitor 425. When the drive switch 426 is turned off, the voltage at the gate of the switch 422 rises from the ground level to the power-supply voltage VCC. A rise time Tᵣ corresponds to a time constant τᵣ determined by the magnitudes of the resistance value Rₛ₁ of the first switch resistor 423, a resistance value Rₛ₂ of the second switch resistor 424, and the capacitance value Cₛ₁ of the switch capacitor 425.

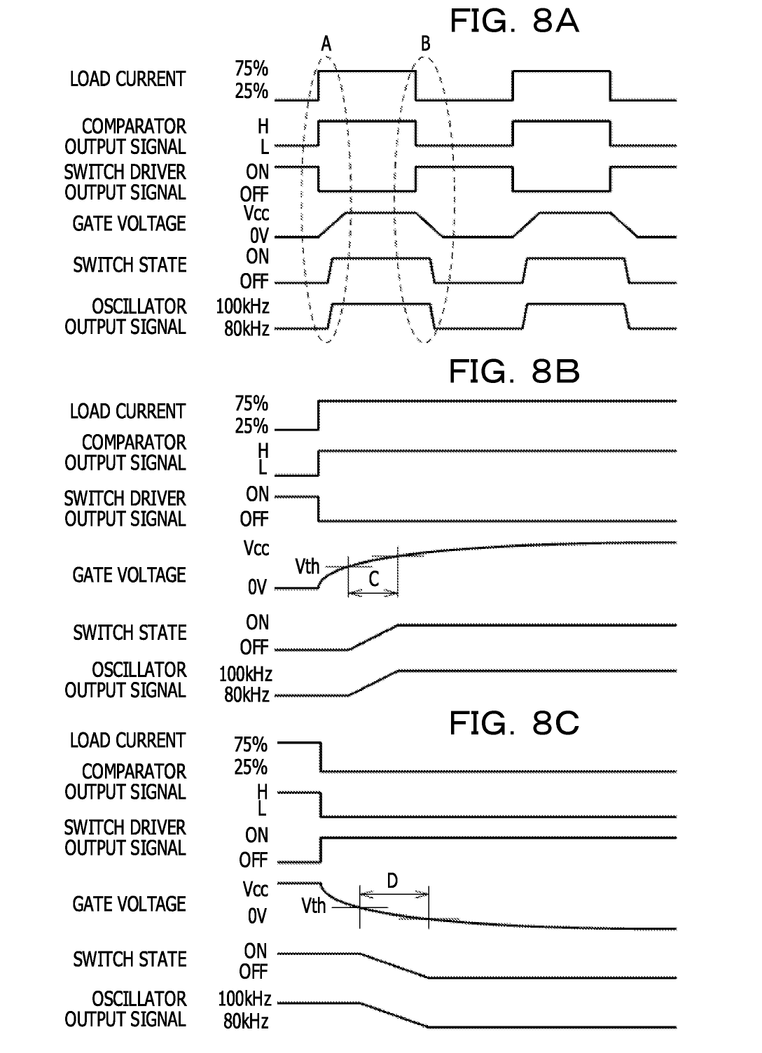

FIG. 8A is a timing chart of the DC-to-DC converter 2, FIG. 8B is a partially enlarged chart of a portion denoted by a dashed-line ellipse A in FIG. 8A, and FIG. 8C is a partially enlarged chart of a portion denoted by a dashed-line ellipse B in FIG. 8A.

In the DC-to-DC converter 2, the rise time Tᵣ of the voltage at the gate of the switch 422 increases according to the time constant τᵣ. When the rise time Tᵣ of the voltage at the gate of the switch 422 increases, the length of a region (indicated by an arrow C in FIG. 8B) in which the switch 422 performs an active operation increases, and the switch 422 is turned on gradually. In the DC-to-DC converter 2, since the switch 422 is turned on gradually, the oscillation frequency f_{OSC} changes gradually from 80 [kHz] to 100 [kHz].

In the DC-to-DC converter 2, the fall time T_{f} of the voltage at the gate of the switch 422 increases according to the time constant τ_{f}. When the fall time T_{f} of the voltage at the gate of the switch 422 increases, the length of a region (indicated by an arrow D in FIG. 8B) in which the switch 422 performs an active operation increases, and the switch 422 is turned off gradually. In the DC-to-DC converter 2, since the switch 422 is turned off gradually, the oscillation frequency f_{OSC} changes gradually from 100 [kHz] to 80 [kHz].

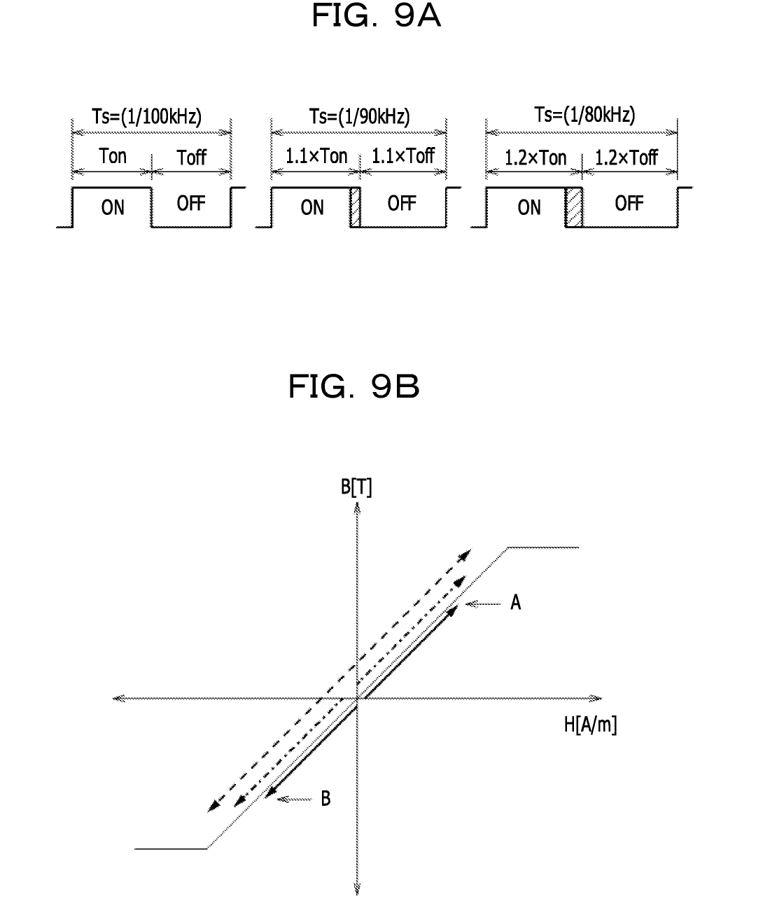

FIG. 9A is a timing chart illustrating switching of the oscillation frequency f_{OSC} of the oscillator 250 in the DC-to-DC converter 2, and FIG. 9B illustrates a B-H curve of the transformer 10 which corresponds to FIG. 9A.

Solid-line arrows in FIG. 9B indicate characteristics when the oscillation frequency f_{OSC} of the oscillator 250 is 100 [kHz], and a dashed-line arrow indicates a characteristic when the oscillation frequency f_{OSC} of the oscillator 250 is 80 [kHz]. Dashed-dotted line arrows indicate characteristics when the oscillation frequency f_{OSC} of the oscillator 250 transiently reaches 90 [kHz] while it decreases from 100 [kHz] to 80 [kHz].

In the DC-to-DC converter 2, when the oscillation frequency f_{OSC} is switched from 100 [kHz] to 80 [kHz], the oscillation frequency f_{OSC} changes gradually, and thus it is possible to switch an operation on the B-H curve while maintaining a symmetry operation at the center point without occurrence of a magnetic flux imbalance. In the DC-to-DC converter 2, since it is possible to switch the operation on the B-H curve while maintaining the symmetry operation at the center point without occurrence of a magnetic flux imbalance, the possibility that magnetic saturation like that described above with reference to FIG. 6B is low. In one example, the time constant τ_{f} may be set so that the fall time T_{f} of the voltage at the gate of the switch 422 during switching the oscillation frequency f_{OSC} from 100 [kHz] to 80 [kHz] is about 100 times the period of the oscillation frequency f_{OSC}.

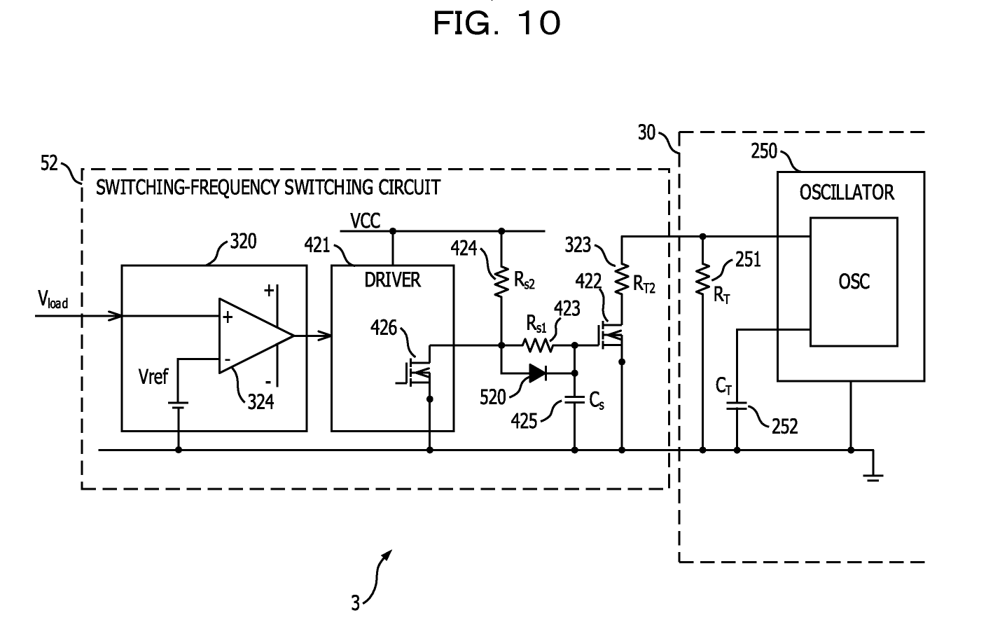

FIG. 10 is a circuit block diagram illustrating a coupling relationship between a PWM-control drive circuit and a switching-frequency switching circuit in a DC-to-DC converter according to a third embodiment.

A DC-to-DC converter 3 is different from the DC-to-DC converter 2 in that a switching-frequency switching circuit 52 is provided instead of the switching-frequency switching circuit 42.

The switching-frequency switching circuit 52 is different from the switching-frequency switching circuit 42 in that a diode 520 is provided parallel to the first switch resistor 423. The diode 520 is provided so that a forward bias is applied when the switch capacitor 425 is charged and a reverse bias is applied when electricity in the switch capacitor 425 is discharged.

In the switching-frequency switching circuit 52, when the drive switch 426 is turned off and the voltage at the gate of the switch 422 rises, the switch capacitor 425 is charged via the diode 520, so that the rise time Tᵣ becomes relatively short. On the other hand, when the drive switch 426 is turned on and the voltage at the gate of the switch 422 falls, the switch capacitor 425 is charged via the first switch resistor 423, so that the voltage at the gate of the switch 422 falls at the fall time T_{f} corresponding to the time constant τ_{f}.

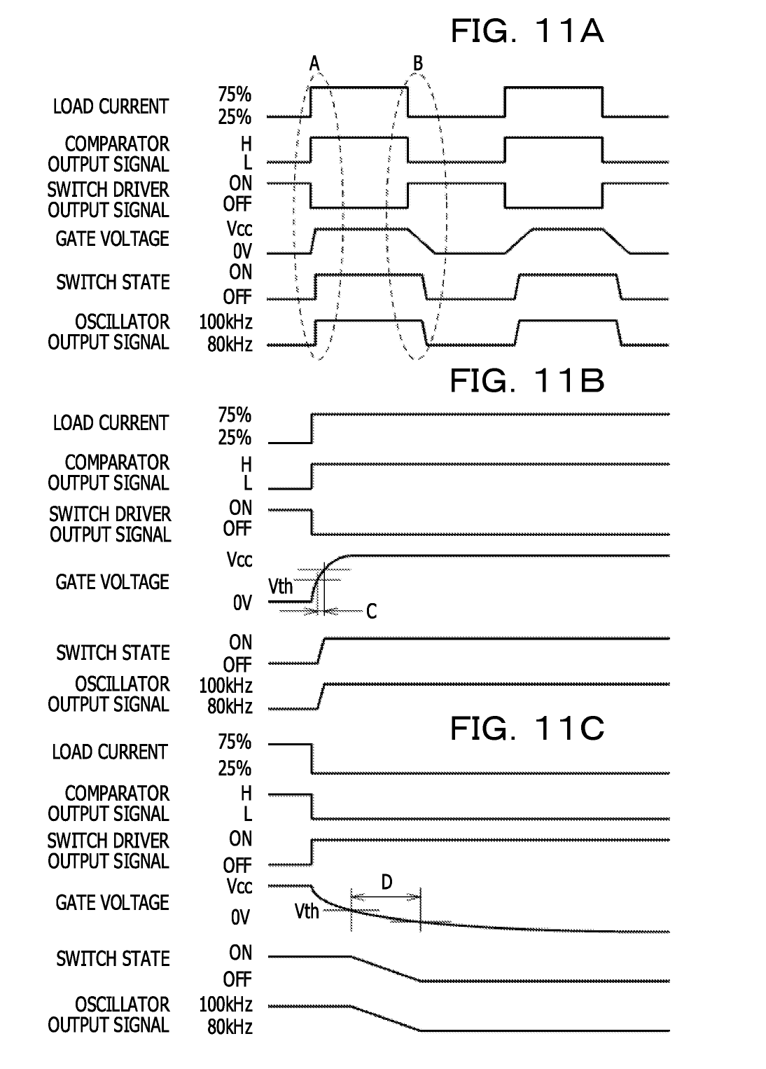

FIG. 11A is a timing chart of the DC-to-DC converter 3, FIG. 11B is a partially enlarged chart of a portion indicated by a dashed-line ellipse A in FIG. 11A, and FIG. 11C is a partially enlarged chart of a portion indicated by a dashed-line ellipse B in FIG. 11A.

In the DC-to-DC converter 3, when the voltage at the gate of the switch 422 rises, current flows via the diode 520, so that the rise time Tᵣ decreases. On the other hand, the fall time T_{f} of the voltage at the gate of the switch 422 increases according to the time constant τ_{f}.

When the voltage at the gate of the switch 422 rises, that is, when the oscillation frequency f_{OSC} of the oscillator 250 increases, the magnetic flux density in the transformer 10 decreases. Thus, there is no possibility of occurrence of the magnetic saturation phenomenon. In the DC-to-DC converter 3, setting the rise time to be relatively short when the voltage at the gate of the switch 422 rises allows the frequency to be changed from a low frequency to a high frequency. Thus, compared with the DC-to-DC converter 2, the power conversion efficiency improves.

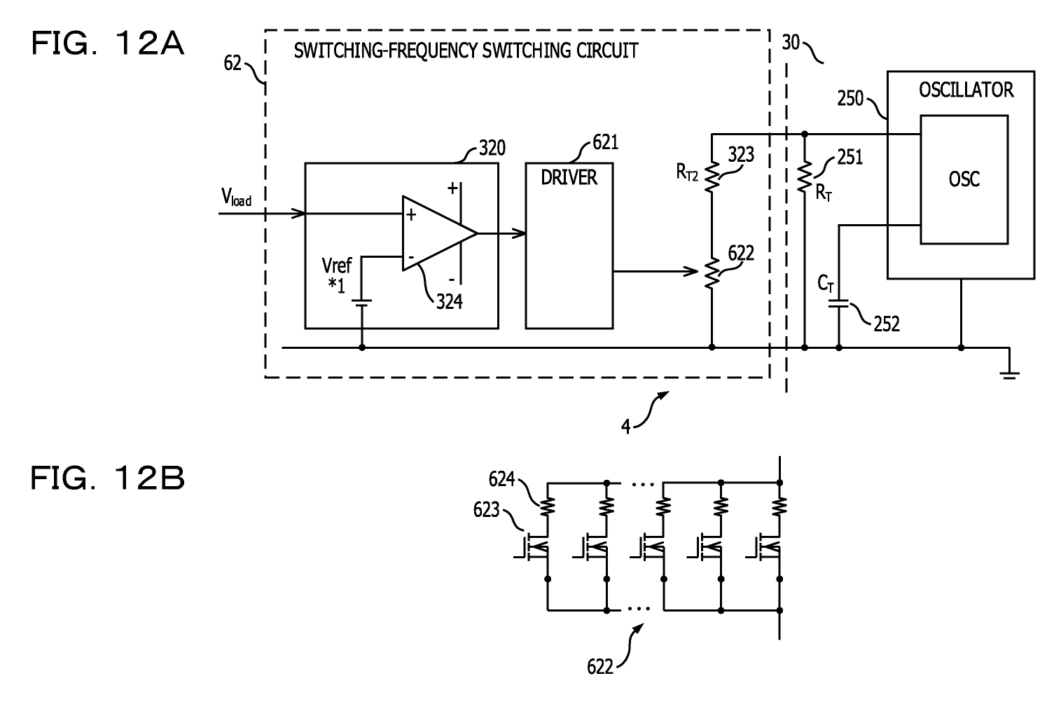

FIG. 12A is a circuit block diagram illustrating a coupling relationship between a PWM-control drive circuit and a switching-frequency switching circuit in a DC-to-DC converter according to a fourth embodiment, and FIG. 12B is an internal circuit block diagram of a variable resistor in FIG. 12A.

A DC-to-DC converter 4 is different from the DC-to-DC converter 1 in that a switching-frequency switching circuit 62 is provided instead of the switching-frequency switching circuit 32.

The switching-frequency switching circuit 62 is different from the switching-frequency switching circuit 32 in that a variable resistor driver 621 is provided instead of the switch driver 321. The switching-frequency switching circuit 62 is also different from the switching-frequency switching circuit 32 in that a variable resistor 622 is provided instead of the switch 322. As illustrated in FIG. 12B, the variable resistor 622 has nMOS transistors 623 and resistors 624 coupled in parallel.

When a signal input from the load-current detector 320 changes from “0” to “1”, the variable resistor driver 621 decides that the load current is larger than a predetermined threshold, and simultaneously turns on some of the nMOS transistors 623. When the variable resistor driver 621 turns on some of the nMOS transistors 623, the resistance value of the variable resistor 622 decreases, and the oscillation frequency f_{OSC} of the oscillator 250 increases. Also, when a signal input from the load-current detector 320 changes from “1” to “0”, the variable resistor driver 621 decides that the load current becomes smaller than the predetermined threshold and turns off some of the nMOS transistors 623. When the variable resistor driver 621 turns off some of the nMOS transistors 623, the resistance value of the variable resistor 622 increases, and the oscillation frequency f_{OSC} of the oscillator 250 decreases.

In the DC-to-DC converters 1 to 4, when the magnitude of the load current detected by the load-current detecting circuit 31 becomes smaller than the predetermined threshold, the oscillation frequency f_{OSC} of the oscillator 250 is switched from a first frequency to a second frequency lower than the first frequency. Also, in the DC-to-DC converters 1 to 4, when the magnitude of the load current detected by the load-current detecting circuit 31 becomes larger than the predetermined threshold, the oscillation frequency f_{OSC} of the oscillator 250 is switched from the second frequency to the first frequency. In the DC-to-DC converters 1 to 4, since the oscillation frequency f_{OSC} of the oscillator 250 at light load decreases, it is possible to reduce capacitance loss that occurs in the first switch 11, the second switch 12, the third switch 13, the fourth switch 14, and so on at light load.

Also, in the DC-to-DC converters 2 to 4, the oscillation frequency f_{OSC} of the oscillator 250 is gradually changed when the oscillation frequency f_{OSC} of the oscillator 250 is switched from the first frequency to the second frequency lower than the first frequency. In the DC-to-DC converters 2 to 4, when the oscillation frequency f_{OSC} of the oscillator 250 is reduced, it is possible to inhibit occurrence of the magnetic saturation phenomenon due to the magnetic flux imbalance in the transformer 10, by gradually changing the oscillation frequency f_{OSC} of the oscillator 250.

Also, in the DC-to-DC converters 3 and 4, when the oscillation frequency f_{OSC} of the oscillator 250 is returned from the second frequency lower than the first frequency to the first frequency, the oscillation frequency f_{OSC} of the oscillator 250 is quickly changed. In the DC-to-DC converters 3 and 4, quickly changing the oscillation frequency f_{OSC} of the oscillator 250 when the oscillation frequency f_{OSC} of the oscillator 250 is increased makes it possible to improve the power conversion efficiency, compared with the DC-to-DC converter 2.

Although the DC-to-DC converters 1 to 4 are configured with hardware, such as transistors, the switching-frequency switching circuits in the DC-to-DC converters 1 to 4 may be partly or entirely realized with software. In one example, the variable resistor driver 621 in the DC-to-DC converter 4 may have an arithmetic unit that executes various types of processing and a storage unit that stores therein a program for the arithmetic unit to execute the processing and data that the arithmetic unit uses to execute the program.

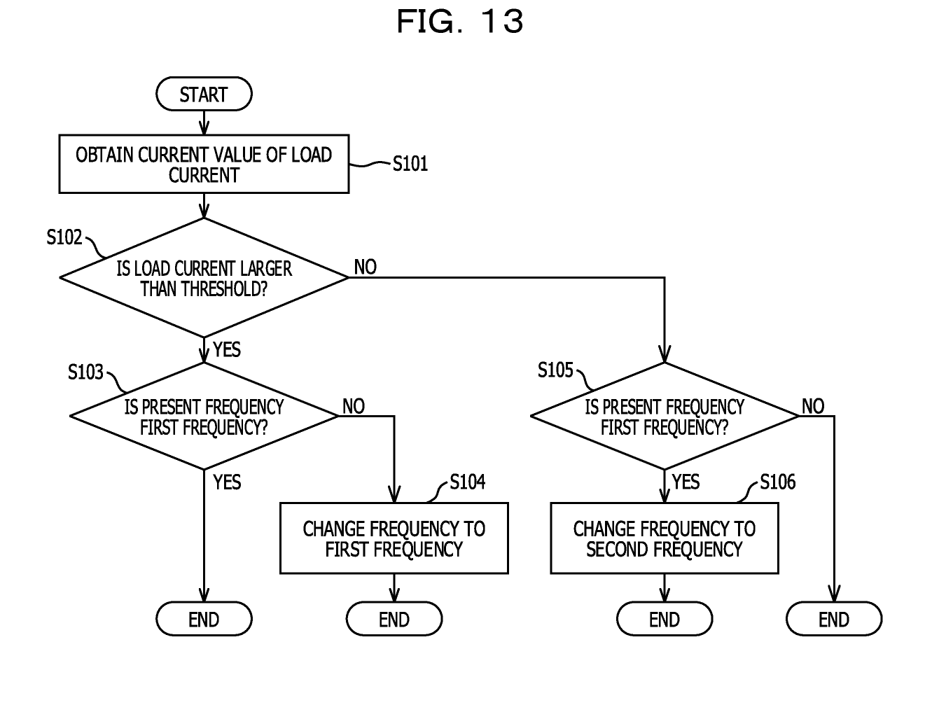

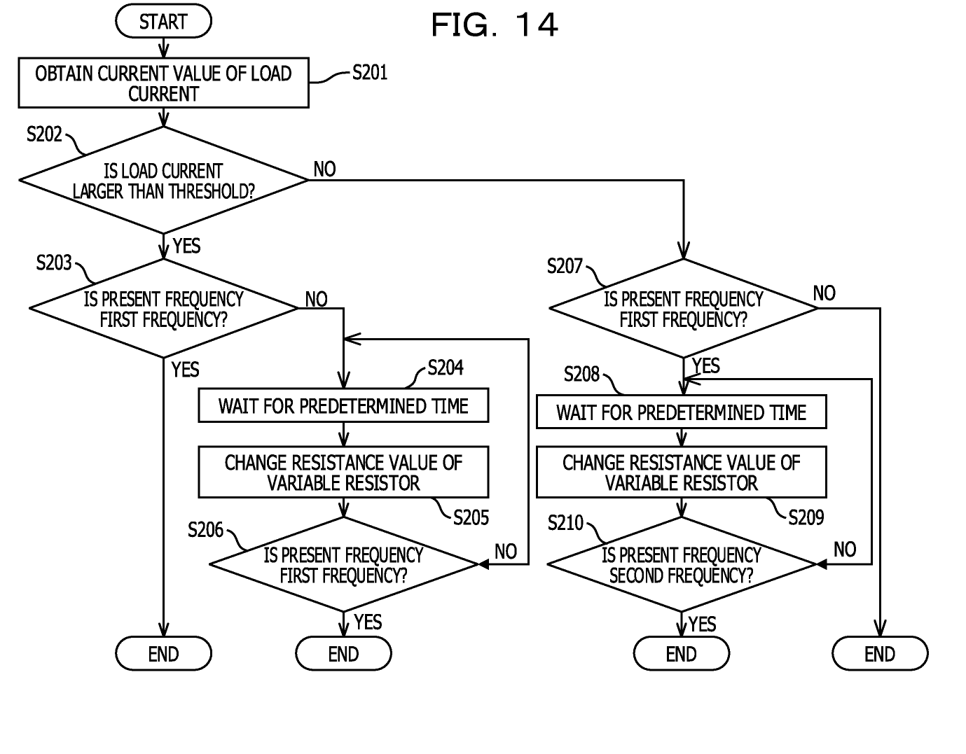

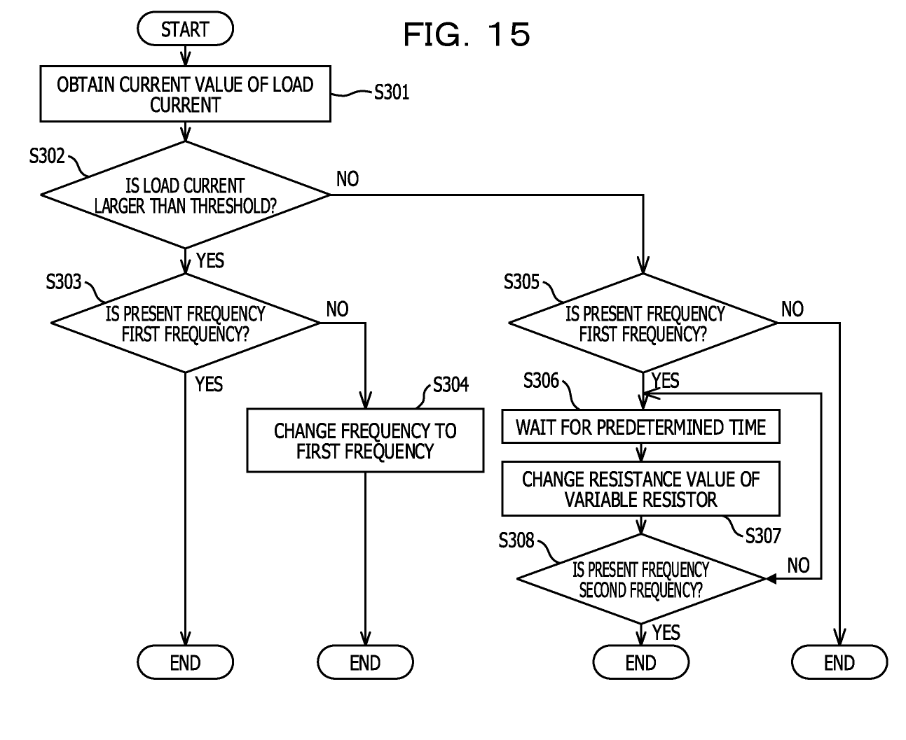

FIG. 13 is a flowchart illustrating an example of processing executed by the variable resistor driver 621 in the DC-to-DC converter 4, and FIG. 14 is a flowchart illustrating another example of the processing executed by the variable resistor driver 621 in the DC-to-DC converter 4. FIG. 15 is a flowchart illustrating yet another example of the processing executed by the variable resistor driver 621 in the DC-to-DC converter 4.

In the example processing illustrated in FIG. 13, first, in step S101, the variable resistor driver 621 obtains, from the load-current detector 320, the current value of load current. Next, in step S102, the variable resistor driver 621 compares the magnitude of the obtained load current with a threshold. If the variable resistor driver 621 determines that the magnitude of the obtained load current is larger than the threshold, the process proceeds to step S103. If the variable resistor driver 621 determines that the magnitude of the obtained load current is not larger than the threshold, the process proceeds to step S105.

If the process proceeds to step S103, the variable resistor driver 621 determines whether or not the present frequency is the first frequency. In one example, the first frequency is 100 [kHz]. If the variable resistor driver 621 determines in step S103 that the present frequency is the first frequency, the processing ends. If the variable resistor driver 621 determines in step S103 that the present frequency is not the first frequency and is the second frequency lower than the first frequency, the process proceeds to step S104. In one example, the second frequency is 80 [kHz]. Next, in step S104, the variable resistor driver 621 reduces the resistance value of the variable resistor 622 to change the frequency from the second frequency to the first frequency.

If the process proceeds to step S105, the variable resistor driver 621 determines whether or not the present frequency is the first frequency. If the variable resistor driver 621 determines in step S105 that the present frequency is the first frequency, the process proceeds to step S106. Next, in step S106, the variable resistor driver 621 increases the resistance value of the variable resistor 622 to change the frequency from the first frequency to the second frequency. If the variable resistor driver 621 determines in step S105 that the present frequency is not the first frequency and is the second frequency lower than the first frequency, the processing ends.

In the example processing illustrated in FIG. 14, first, in step S201, the variable resistor driver 621 obtains, from the load-current detector 320, the current value of load current. Next, in step S202, the variable resistor driver 621 compares the magnitude of the obtained load current with a threshold. If the variable resistor driver 621 determines that the magnitude of the obtained load current is larger than the threshold, the process proceeds to step S203. If the variable resistor driver 621 determines that the magnitude of the obtained load current is not larger than the threshold, the process proceeds to step S207.

If the process proceeds to step S203, the variable resistor driver 621 determines whether or not the present frequency is the first frequency. If the variable resistor driver 621 determines in step S203 that the present frequency is the first frequency, the processing ends. If the variable resistor driver 621 determines in step S203 that the present frequency is not the first frequency and is the second frequency lower than the first frequency, the process proceeds to step S204. In step S204, the variable resistor driver 621 waits for a predetermined time. Next, in step S205, the variable resistor driver 621 reduces the resistance value of the variable resistor 622 by a predetermined amount. Next, in step S206, the variable resistor driver 621 determines whether or not the resistance value of the variable resistor 622 is a resistance value for the first frequency. If the variable resistor driver 621 determines in step S206 that the resistance value of the variable resistor 622 is a resistance value for the first frequency, the processing ends. If the variable resistor driver 621 determines in step S206 that the resistance value of the variable resistor 622 is not a resistance value for the first frequency, the process returns to step S204.

If the process proceeds to step S207, the variable resistor driver 621 determines whether or not the present frequency is the first frequency. If the variable resistor driver 621 determines in step S207 that the present frequency is not the first frequency and is the second frequency lower than the first frequency, the processing ends. If the variable resistor driver 621 determines in step S207 that the present frequency is the first frequency, the process proceeds to step S208. In step S208, the variable resistor driver 621 waits for a predetermined time. Next, in step S209, the variable resistor driver 621 increases the resistance value of the variable resistor 622 by a predetermined amount. Next, in step S210, the variable resistor driver 621 determines whether or not the resistance value of the variable resistor 622 is a resistance value for the second frequency. If the variable resistor driver 621 determines in step S210 that resistance value of the variable resistor 622 is a resistance value for the second frequency, the processing ends. If the variable resistor driver 621 determines in step S210 that the resistance value of the variable resistor 622 is not a resistance value for the second frequency, the process returns to step S208.

In the example processing illustrated in FIG. 15, first, in step S301, the variable resistor driver 621 obtains, from the load-current detector 320, the current value of load current. Next, in step S302, the variable resistor driver 621 compares the magnitude of the obtained load current with a threshold. If the variable resistor driver 621 determines that the magnitude of the obtained load current is larger than the threshold, the process proceeds to step S303. If the variable resistor driver 621 determines that the magnitude of the obtained load current is not larger than the threshold, the process proceeds to step S305.

If the process proceeds to step S303, the variable resistor driver 621 determines whether or not the present frequency is the first frequency. If the variable resistor driver 621 determines in step S303 that the present frequency is the first frequency, the processing ends. If the variable resistor driver 621 determines in step S303 that the present frequency is not the first frequency and is the second frequency lower than the first frequency, the process proceeds to step S304. In step S304, the variable resistor driver 621 reduces the resistance value of the variable resistor 622 to change the frequency from the second frequency to the first frequency.

If the process proceeds to step S305, the variable resistor driver 621 determines whether or not the present frequency is the first frequency. If the variable resistor driver 621 determines in step S305 that the present frequency is not the first frequency and is the second frequency lower than the first frequency, the processing ends. If the variable resistor driver 621 determines in step S305 that the present frequency is the first frequency, the process proceeds to step S306. In step S306, the variable resistor driver 621 waits for a predetermined time. Next, in step S307, the variable resistor driver 621 increases the resistance value of the variable resistor 622 by a predetermined amount. Next, in step S308, the variable resistor driver 621 determines whether or not the resistance value of the variable resistor 622 is a resistance value for the second frequency. If the variable resistor driver 621 determines in step S308 that the resistance value of the variable resistor 622 is a resistance value for the second frequency, the processing ends. If the variable resistor driver 621 determines in step S308 that the resistance value of the variable resistor 622 is not a resistance value for the second frequency, the process returns to step S306.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A direct current to direct current converter comprising:
a transformer configured to vary a direct-current voltage applied to a first side and output the varied direct-current voltage to a second side;
a switch configured to periodically switch the voltage applied to the first side of the transformer;
a load-current detecting circuit configured to detect load current flowing in the second side of the transformer; and
a switching-frequency switching circuit configured to switch,
when a magnitude of the load current detected by the load-current detecting circuit is smaller than a predetermined threshold, a frequency for switching the switch from a first frequency to a second frequency lower than the first frequency, and to switch,
when the magnitude of the load current detected by the load-current detecting circuit is larger than the predetermined threshold, the frequency for switching the switch from the second frequency to the first frequency.

2. The direct current to direct current converter according to claim 1,
wherein, during the switching of the frequency for switching the switch from the first frequency to the second frequency lower than the first frequency, the switching-frequency switching circuit gradually reduces the frequency.

3. The direct current to direct current converter according to claim 2,
wherein a transition time in which the frequency for switching the switch from the first frequency to the second frequency is longer than a transition time in which the frequency for switching the switch is switched from the second frequency to the first frequency.

4. The direct current to direct current converter according to claim 1,
wherein the switch comprises a plurality of metal oxide semiconductor transistors.
